(19) United States
(12) Patent Application Publication
(10) Pub. No.: US 2010/0267595 A1
(43) Pub. Date: Oct. 21, 2010

(54) COATED COMPONENT AND METHOD FOR PRODUCING SUCH A COMPONENT

(76) Inventors: Andreas Vogt, Renningen (DE); Thomas Kleinbeck, Vaihingen/Enz (DE)

Correspondence Address: KENYON & KENYON LLP, ONE BROADWAY, NEW YORK, NY, 10004, US

(21) Appl. No.: 12/733,839

(22) PCT Filed: Sep. 25, 2008
(86) PCT No.: PCT/EP2008/062811

§ 371 Date: Jul. 1, 2010

(30) Foreign Application Priority Data
Oct. 1, 2007 (DE) 102007047015.2

(51) Int. Cl. B32B 5/16; B05D 1/00

(52) U.S. Cl. 508/108; 508/100; 508/109; 427/202

(57) ABSTRACT

A component having a layer system situated on the component is described, for increasing the resistance to wear of the component. The layer system in this context includes a phosphate layer and particles of solid lubricants, the layer system being free of any binding agent. A method for producing such a component is also described.

### FIELD OF THE INVENTION

The present invention relates to a coated component and a method for producing such a component. The component has a coating system, in this context, for increasing its resistance to wear.

### BACKGROUND INFORMATION

Components that are exposed to tribological stresses are often provided with a dry lubricant. Dry lubricants, that are applied to the component, increase its resistance to wear. On this subject, it is also known that one may place dry lubricants in the form of particles on the surface of the component.

Thus, for example, in DE 196 46 524 A1 wear-resistant parts are discussed that have dry lubricants applied to them. In that document it is proposed that one provide a layer system which includes a first and a second coating. The second coating is formed on the first coating and includes a solid dry lubricant. In order to fix the particles of the dry lubricant on the surface of the component, a binding agent, such as resins, is used. Thus, the second coating, in this case, is essentially a binding agent having particles embedded in it.

However, technical disadvantages come about from the utilization of a binding agent for the fixing of the particles of solid lubricants. For one thing, all binder systems have the disadvantage that a tight tolerance with regard to the layer thickness is not ensured. In a layer thickness of typically 15 to 20 the variance of the layer thickness amounts to about 5 μm. On the other hand, binder systems are relatively easily worn off, based on their own low resistance to wear in response to mechanical stress. This process first of all leads to a geometrical change in the coating system, and later, after the complete removal of the binder system, it leads to functional loss of the coating.

### SUMMARY OF THE INVENTION

It is therefore an object of the exemplary embodiments and/or exemplary methods of the present invention to provide a coated component and a method for its production, in which, on the one hand, a tight layer thickness tolerance is ensured and, on the other hand, its resistance to wear is further enhanced.

The exemplary embodiments and/or exemplary methods of the present invention yields the advantage that tight tolerances with respect to the layer thickness of a coated component are achieved. This advantage is achieved by doing without any binding agent whatsoever in the layer system or on the entire coated component. Neither organic nor inorganic binding agents are provided according to the exemplary embodiments and/or exemplary methods of the present invention.

Because of the renunciation of the binding agent, the material costs of a coated component advantageously become more cost-effective in comparison to a component that has a binding agent in the coating system.

Furthermore, because of the renunciation of the binding agent, the wear rate of a lubricant or of a “solid lubricant coating”, SLC, on the surface of the component, is advantageously able to be greatly reduced.

Advantageous further developments of the exemplary embodiments and/or exemplary methods of the present invention are delineated and described in the specification.

### DETAILED DESCRIPTION

A component is provided, having a layer system situated on the component, for increasing the resistance to wear of the component, the layer system including a phosphate layer and particles of solid lubricant. In this instance, the layer system, according to the exemplary embodiments and/or exemplary methods of the present invention, is completely free of binding agent. Up to now, binding agent systems, in the related art, had the function of fixing the solid lubricants to the surface of a tribologically challenged component. Without use of a binding agent, that is, the fixing of solid lubricants to the components was not able to be implemented.

Instead, only one method is explained, using which, the production of a component according to the present invention, i.e. a component having a layer system including a solid lubricant without a binding agent, is made possible. The basic method steps include:
a) providing a component that is to be coated,
b) the coating of the component by applying a binding agent-free layer system, having a phosphate layer on the component, and
c) introducing particles of solid lubricants, particularly graphite or MoS₂, or a combination of these two substances, into the layer system using particle injection.

In the particle injection in step c), the particles are shot onto the surface of the component that is coated with the phosphate layer. The acceleration of the particles required for this may be ensured using air pressure. At a sufficiently high kinetic energy of the particles, they penetrate into the layer system, and are thus fixed on the surface of the component.

Although the layer system on the component may basically be made up of a plurality of individual layers, the method is particularly effective if, in step b), the component is coated only with the phosphate layer, as the only layer of the layer system. For, if the phosphate layer is the only layer of the layer system, the total thickness of the layer system is further reduced. Also, applying the layer system, when it is a single layer, is naturally simpler and faster than in the case of a two-layer system or even a multi-layer system. The layer thickness tolerance is considerably improved, in particular.

Independently of the number of individual layers of the layer system, the particles of solid lubricants may be embedded in the phosphate layer. The combination of solid lubricant and phosphate layer, thus formed, advantageously has low friction and high resistance to wear.

Furthermore, a phosphate layer may be preferred that has a porous or fine crystalline structure. It makes the penetration of the particles of solid lubricants into the phosphate layer easier. At least the surface area of the phosphate layer should have cavities or pores. These cavities provide the possibility that the particles of solid lubricants will be able to be driven into these cavities, and consequently be firmly anchored in the phosphate layer.

A thickness of the phosphate layer of about 2 to 4 μm is regarded as particularly suitable. This thickness is sufficient on the one hand, so as to be able to take up enough solid lubricant to improve the resistance to wear, and on the other hand, it is not unnecessarily too thick.

With regard to the exact materials of the phosphate layer, iron phosphate or manganese phosphate are proposed, in particular. In practical series of experiments, it was possible to show their special suitability for use in the exemplary embodiments and/or exemplary methods of the present invention.

It was also established that graphite and MoS₂, or a combination of these two substances, are able to be used as the solid lubricant.

Finally, the component coated according to the exemplary embodiments and/or exemplary methods of the present invention and the method for its production may be used in many technical fields. Among those are particularly components operated under high tribological stress, such as components in the automotive field. In this connection, an example is high pressure pumps, which work on the piston/cylinder principle.

1-10. (canceled)

11. A component, comprising:
a component arrangement;
a layer system situated on the component arrangement for increasing a resistance to wear of the component arrangement;
wherein the layer system includes a phosphate layer and particles of solid lubricants, and
wherein the layer system is free of any binding agent.

12. The component of claim 11, wherein the phosphate layer is the only layer of the layer system.

13. The component of claim 11, wherein the particles of solid lubricants are embedded in the phosphate layer.

14. The component of claim 11, wherein the phosphate layer has one of a porous structure and a fine crystalline structure.

15. The component of claim 11, wherein at least the surface area of the phosphate layer has cavities.

16. The component of claim 11, wherein the phosphate layer has a thickness of about 2 um to 4 μm.

17. The component of claim 11, wherein the phosphate layer contains one of iron phosphate and manganese phosphate.

18. The component of claim 11, wherein the solid lubricant includes at least one of graphite and MoS₂.

19. A method for producing a coated component, the method comprising:
providing a component that is to be coated;
applying a coating to the component by applying a binding agent-free layer system, having a phosphate layer on the component; and
introducing particles of solid lubricants into the layer system using particle injection;
wherein the layer system is situated on the component for increasing a resistance to wear of the component, wherein the layer system includes the phosphate layer and the particles of solid lubricants, and wherein the binding agent-free layer system is free of any binding agent.

20. The method of claim 19, wherein the component is coated only using the phosphate layer as the only layer of the layer system.

21. The method of claim 19, wherein the solid lubricant includes at least one of graphite and MoS₂.
